(19) United States
(12) Patent Application Publication
(10) Pub. No.: US 2017/0264652 A1
(43) Pub. Date: Sep. 14, 2017

(54) CROSS-PLATFORM VIDEO CONVERSATION BETWEEN RELATED DEVICES

(71) Applicant: T-Mobile USA, Inc., Bellevue, WA (US)

(72) Inventors: Yasmin Karimli, Kirkland, WA (US); Gunjan Nimbavikar, Bellevue, WA (US)

(21) Appl. No.: 15/212,760

(22) Filed: Jul. 18, 2016

Related U.S. Application Data
(63) Continuation-in-part of application No. 15/063,749, filed on Mar. 8, 2016.

(51) Int. Cl. H04L 29/06; H04M 3/42

(52) U.S. Cl. CPC H04L 65/403; H04L 65/1006; H04L 65/1016; H04L 65/601; H04M 3/42365

(57) ABSTRACT

Cross-platform video conversation between related devices is described. Techniques described herein include receiving, by a first device registered with a network to utilize a communication address for sending and receiving cellular communications via the network, live video associated with a video conversation between the first device and a second device. Information for related device(s) may be retrieved by the first device. The related device(s) may be related to the first device based on utilizing the communication address for sending and receiving at least communications via the network and/or being associated with a same subscriber account as the first device. Moreover, techniques described herein enable the first device to share the live video with related device(s) to enable the related device(s) to join the video conversation irrespective of which computing platform provides conversational video services for each of the related device(s).

### RELATED APPLICATION

This application is a continuation-in-part of co-pending U.S. application Ser. No. 15/063,749, filed Mar. 8, 2016 and entitled “Content Sharing Between Related Devices,” the entire contents of which are incorporated herein by reference.

### BACKGROUND

Users have multiple telecommunication devices such as cellular phones, tablet computers, laptops, and other devices. Each device may have its own communication address, such as a telephone number, and may receive communications directed to any communication address associated with a service account.

In (IP) Multimedia Subsystem (IMS), call forking may be achieved through implicit registration sets (IRS). With IRS, when any one network identity (e.g., IP Multimedia Public Identifier (IMPU)) associated with a communication address is registered, other network identities associated with a same service account as that network identity are also registered. When a communication is received and directed to any one network identity of the registration set, it may be sent to all network identities of that registration set.

Session Initiation Protocol (SIP), as extended by RFC 3265 (“Session Initiation Protocol (SIP)-Specific Event Notification”, June 2002), utilizes a subscribe method to request a current state as well as state updates from a remote node. The specification for Open Mobile Alliance (OMA) Presence SIMPLE (SIP for Instant Messaging and Presence Leveraging Extensions) defines mechanisms for utilizing SIP to perform instant messaging and other functions. Rich Communication Services (RCS) is a GSM Association (GSMA) program that provides for inter-operability within an IP Multimedia Subsystem (IMS). One feature of RCS is the ability to discover capabilities of contacts. RCS utilizes OMA Presence SIMPLE for various features, including subscription to a presence server to obtain capability information for a list of contacts.

In some examples, users may communicate with other users via conversational video services including, but not limited to, videotelephony, videoconferencing, etc. Videotelephony enables communication via live, simultaneous two-way video and audio transmissions between two devices. Videoconferencing enables two or more locations to communicate via live, simultaneous two-way video and audio transmissions via a multipoint control unit. Various computing platforms enable conversational video services.

In at least one example, IR.94 is a GSMA program that defines an IMS profile for conversational video services to enable voice/video calling services over Long-Term Evolution (LTE) cellular networks. IR.94 is the definition of an IMS profile by listing a number of Evolved Universal Terrestrial Radio Access Network (E-UTRAN), Evolved Packet Core, IMS core, and user equipment (UE) features, which are considered essential to launch interoperable IMS based conversational video services.

In additional and/or alternative examples, web-based applications including, but not limited to, FACETIME®, SKYPE®, GOOGLE+ HANGOUTS®, etc. may provide conversational video services. FACETIME® is an application that facilitates one-on-one video conversation via Voice over IP (VOIP). SKYPE® is an application that provides video conversation and voice call services. SKYPE® allows users to communicate over the Internet by voice, video, etc. GOOGLE+ HANGOUTS® is an application that enables two or more users to communicate via instant messaging, video conversation, Short Message Service (SMS), and VOIP features.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an environment for facilitating cross-platform video conversation between related devices.

FIG. 2 illustrates additional details of the environment for facilitating cross-platform video conversation between related devices illustrated in FIG. 1.

FIG. 3A illustrates a user interface that enables a user to select related devices to join a video conversation with an external device.

FIG. 3B illustrates a user interface for a related device that enables a user to select to join a video conversation between another related device and an external device.

FIG. 4 illustrates an example mobile device configured to enable related devices to join a video conversation with an external device.

FIG. 5 illustrates an example presence server configured to provide presence information for related devices.

FIG. 6 illustrates an example process for enabling sharing video conversations between related devices.

FIG. 7 illustrates an example process for sharing video conversations between related devices.

FIG. 8 illustrates another example process for sharing video conversations between related devices.

FIG. 9 illustrates yet another example process for sharing video conversations between related devices.

FIG. 10 illustrates an example process for enabling sharing of video conversations between related devices.

### DETAILED DESCRIPTION

In examples of the present disclosure, related devices are enabled to facilitate cross-platform video conversation between other ones of the related devices. A group of related devices includes devices that are associated with the same subscriber account, share the same cellular telephone line, and so forth. Devices sharing the same subscriber account are often associated with an international mobile subscriber identity (IMSI). Devices sharing the same telephone line are configured to send, receive, and initiate, cellular communications using a shared identifier, communications address, and so forth, such as a telephone number, MSISDN (sometimes referred to as the “Mobile Station International Subscriber Directory Number”), IP Multimedia Public Identifiers (IMPU), and so forth. Thus, devices are related in some examples based on their being associated with the same “account” (e.g., associated with an IMSI), associated with the same “line” (e.g., associated with the same communication address), and so forth. That is, for the purpose of this discussion, devices that are associated with a same account and/or a same line are called “related devices.” In some examples, related devices include devices for which incoming calls and messages (such as Short Message Service (SMS) messages) sent to the common communication address may be sent to all of the related devices.

In some examples, users may communicate with other users via conversational video services including, but not limited to, videotelephony, videoconferencing, etc. Videotelephony enables communication via live, simultaneous two-way video and audio transmissions between two devices. Videoconferencing enables two or more locations to communicate via live, simultaneous two-way video and audio transmissions via a multipoint control unit. As described above, various computing platforms may facilitate conversational video services. In at least one example, IR.94 is a GSMA program that defines an IMS profile for conversational video services to enable voice/video calling services over LTE cellular networks. In additional and/or alternative examples, web-based applications including, but not limited to, FACETIME®, SKYPE®, GOOGLE+ HANGOUTS®, etc. may provide conversational video services. For the purpose of this discussion, communication via conversational video services may be called a “video conversation.” In at least one example, a video conversation may involve the exchange of live, simultaneous (i.e., real-time) video and audio transmissions between devices that are participating in the video conversation.

In examples of the present disclosure, a related device that is participating in a video conversation with an external device may invite one or more of the related devices to join the video conversation. That is, in at least one example, a related device that is participating in a video conversation with an external device may share the video conversation with one or more of the related devices to allow the one or more of the related devices to join the video conversation. In such examples, the video conversation may be shared with the one or more other related devices using a cellular network, or using another access network such as via a Wi-Fi network that provides access to the Internet or other network(s). In examples of the present disclosure, a related device may share a video conversation with one or more other related devices irrespective of the computing platform providing conversational video services for each of the one or more other related devices. Additionally, a related device may share a video conversation with one or more other related devices without interrupting the video conversation between the related device and the external device.

Various examples of the present disclosure are described below in reference to the figures.

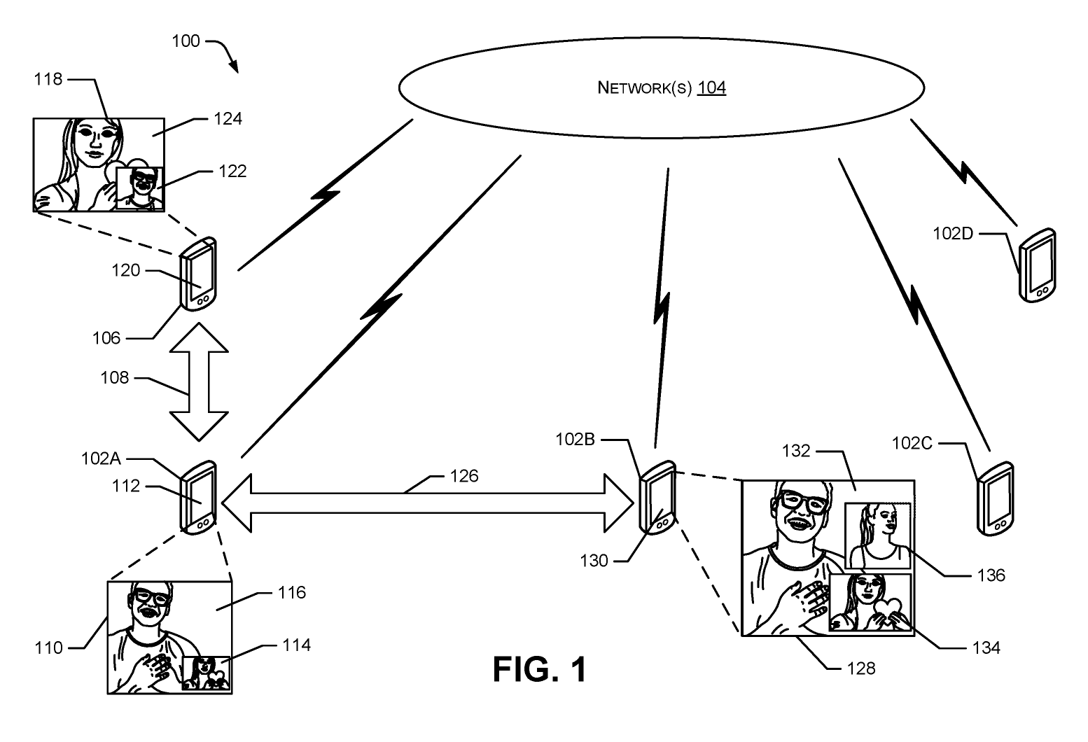

FIG. 1 illustrates an environment 100 for facilitating cross-platform video conversation between related devices. As described above, in at least one example, a video conversation between a related device and an external device may be shared with one or more other related devices. The sharing of a video conversation may be within a contained grouping of related devices, such that other devices that do not share an account, line, etc. are not permitted to receive the content. In environment 100, device 102A, device 102B, device 102C, and device 102D are examples of related devices. While four related devices are shown, any number of devices may be related so long as they share at least one of a line or an account with another device.

The related devices (e.g., device 102A, device 102B, device 102C, and device 102D) are each communicatively coupled to network(s) 104. As described herein, network(s) 104 may include a cellular network, the Internet, and/or another network. In at least one example, presence information for the related devices (e.g., device 102A, device 102B, device 102C, and device 102D) may be obtained from a presence server associated with the network(s) 104, such as a SIP server or other. Presence information obtained from the presence server—such as Internet Protocol (IP) addresses or other network address information—may be utilized to establish a connection amongst related devices (e.g., device 102A, device 102B, device 102C, and/or device 102D) to share video conversations. Presence information obtained from the presence server may be utilized to identify related devices (e.g., device 102A, device 102B, device 102C, and device 102D). Presence information obtained from the presence server may be utilized to identify those related devices (e.g., device 102A, device 102B, device 102C, and/or device 102D) that are currently online.

The presence server may also be utilized to establish communications sessions between related devices (e.g., device 102A, device 102B, device 102C, and/or device 102D), and may enforce a sharing policy for sharing video conversations, such as a sharing policy that allows a video conversation to be shared amongst related devices (e.g., device 102A, device 102B, device 102C, and/or device 102D), and prevents the video conversation from being shared with devices that do not share a line and/or an account with a related device initially participating in the video conversation. For the purpose of this discussion, devices that do not share a line and/or an account with one or more related devices may be called “external devices.” In environment 100, device 106 is an example of an external device.

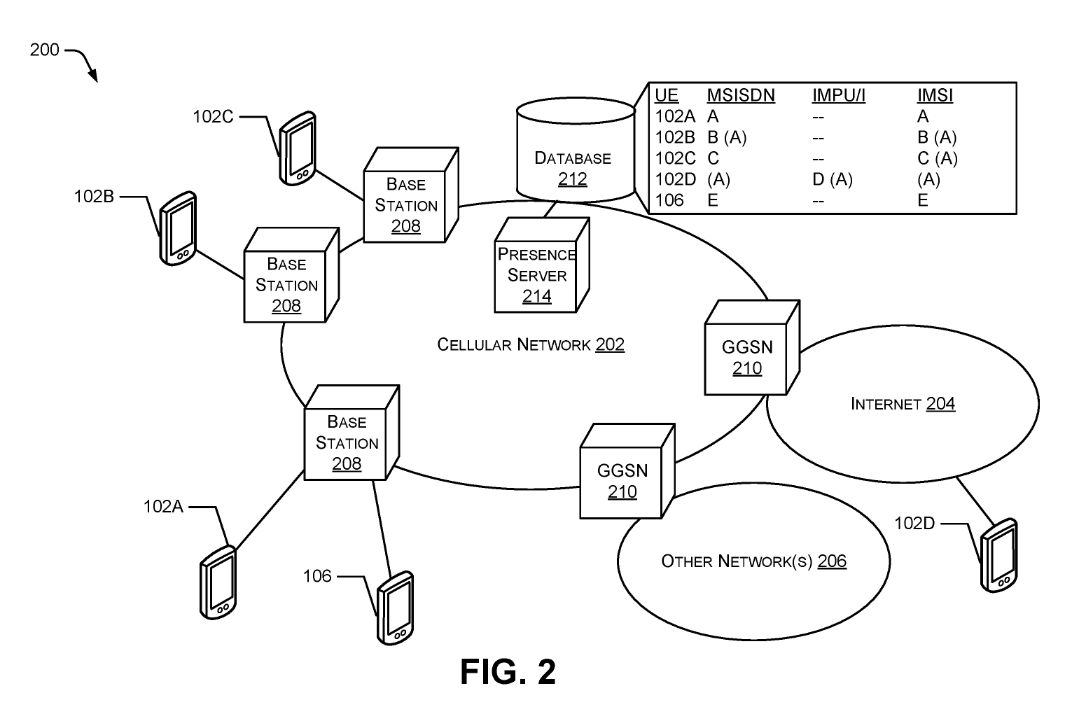

Additional details associated with the presence server are described below with reference to FIG. 2.

In environment 100, device 102A is participating in a video conversation with an external device (e.g., device 106), as represented by arrow 108. That is, device 102A and device 106 are participating in live, simultaneous two-way video and audio transmissions. User interface 110 is a non-limiting example of a user interface that may be presented via a display 112 of device 102A. In at least one example, the user interface 110 may present the live, simultaneous two-way video transmissions exchanged between device 102A and device 106. In some examples, the user interface 110 may present live video received from another device such that the live video is presented on the entire user interface 110. In other examples, as illustrated in FIG. 1, live video corresponding to each device (e.g., device 102A and device 106) that is participating in a video conversation may be displayed in a particular region of the user interface 110. In at least one example, a first region of the user interface 110 may be presented as a picture-in-picture presentation of a second region of the user interface 110. In other examples, a first region of the user interface 110 may be presented in a side-by-side presentation with a second region of the user interface 110. Additional and/or alternative presentations may be imagined.

In FIG. 1, live video transmitted by device 102A may be presented in a first region 114 of the user interface 110. That is, the first region 114 of the user interface 114 may present live video of the user corresponding to device 102A and/or the environment associated with the user corresponding to device 102A. Live video transmitted by device 106 may be presented in a second region 116 of the user interface 110. That is, the second region 116 of the user interface 114 may present live video of the user corresponding to device 106 and/or the environment associated with the user corresponding to device 106.

User interface 118 is a non-limiting example of a user interface that may be presented via a display 120 of device 106. Live video transmitted by device 106 may be presented in a first region 122 of the user interface 118. That is, the first region 122 of the user interface 118 may present live video of the user corresponding to device 106 and/or the environment associated with the user corresponding to device 106. That is, in at least one example, the first region 122 of user interface 118 and the second region 116 of user interface 110 may present the same live video transmission associated with device 106. Live video transmitted by device 102A may be presented in a second region 124 of the user interface 118. That is, the second region 124 of the user interface 118 may present a video of the user corresponding to device 102A and/or the environment associated with the user corresponding to device 102A. That is, in at least one example, the second region 124 of user interface 118 and the first region 114 of user interface 110 may present the same live video transmission associated with device 102A.

As described herein, in some examples, a related device (e.g., device 102A) that is participating in a video conversation with an external device (e.g., device 106) may invite one or more related devices (e.g., device 102B, device 102C, and/or device 102D) to join the video conversation. That is, device 102A may share the video conversation with device 102B to invite device 102B to join the video conversation, as represented by arrow 126. As a result, device 102B, which is related to device 102A, may select to join the video conversation. In other examples, a related device (e.g., device 102A) that is participating in a video conversation with an external device (e.g., device 106) may automatically (i.e., without user intervention) share the video conversation with device 102B to enable device 102B to join the video conversation, as represented by arrow 126. As a result, device 102B, which is related to device 102A, may join the video conversation.

As shown, user interface 128 is a non-limiting example of a user interface that may be presented via a display 130 of device 102B. Live video transmitted by device 106 may be presented in a first region 132 of the user interface 128. That is, the first region 132 of the user interface 128 may present live video of the user corresponding to device 106 and/or the environment associated with the user corresponding to device 106. Live video transmitted by device 102A may be presented in a second region 134 of the user interface 128. That is, the second region 134 of the user interface 128 may present live video of the user corresponding to device 102A and/or the environment associated with the user corresponding to device 102A. Live video transmitted by device 102B may be presented in a third region 136 of the user interface 128. That is, the third region 136 of the user interface 128 may present live video of the user corresponding to device 102B and/or the environment associated with the user corresponding to device 102B.

In at least one example, device 102A may invite device 102B to join the video conversation, and subsequently share the video conversation with the device 102B, without interrupting the current video conversation represented by arrow 108. In some examples, device 102B may be associated with a different computing platform for providing conversational services than device 102A. For instance, device 102B may be associated with IR.94 technology and device 102A may be communicating with device 106 via a web-based application, such as FACETIME®. Techniques described herein enable a related device (e.g., device 102A) to share video conversations with other related devices (e.g., device 102B, device 102C, and/or device 102D) without regard to the computing platforms for facilitating video conversation associated with each of the related devices. Additionally, techniques described herein enable the related device (e.g., device 102A) to share a video conversation without disrupting the video conversation.

FIG. 2 illustrates an environment 200 for facilitating cross-platform video conversation between related devices.

In at least one example, related device (e.g., device 102A) communicates with an external device (e.g., device 106) and one or more related devices (e.g., device 102B, device 102C, and/or device 102D) via cellular network 202, the Internet 204, and/or one or more other networks 206. The cellular network 202, the Internet 204, and/or the one or more other networks 206 may correspond to network(s) 104 with reference to FIG. 1. In at least one example, device 102A, device 102B, device 102C, and/or device 106 may connect to the cellular network 202 via a corresponding base station 208. The cellular network 202 may be responsible for routing voice communication to other networks 206, as well as routing data communication to external packet switched networks, such as the Internet 204. For example, the cellular network 202 may include a Gateway GPRS Support Node (GGSN) 210 or another equivalent node.

Each of the related devices (e.g., device 102A, device 102B, device 102C, and/or device 102D) and the external device 106 may correspond to user equipment (UE). The UE may include, but is not limited to, one or more of a smart phone, a personal digital assistant, a netbook, a laptop computer, a smart appliance, and/or another electronic device that is capable of sending or receiving voice, video, and/or data via the cellular network 202, the Internet 204, and/or one or more other network(s) 206 (e.g., a Wi-Fi network, another access network, etc.).

In an example where a UE is a mobile device, the mobile device may include a subscriber identity module (SIM) card 118, which has an international mobile subscriber identity (IMSI) stored thereon. An IMSI is a unique 64-bit number. Within a GSM network, the IMSI is associated with the MSISDN, sometimes referred to as the “Mobile Station International Subscriber Directory Number,” or more commonly as the telephone number. The MSISDN is a unique number that identifies a subscription on a GSM network and is also the number that may be used to place a call to the GSM phone. The MSISDN is not necessarily stored on the SIM card 118 or the phone, and the MSISDN is not permanently associated with the IMSI. The MSISDN may change if the subscription changes, for example.

In some examples, multiple UEs are registered with a common number (e.g., MSISDN, IMPU, IMPI, etc.) (“line,” as used herein) and/or are associated with a common subscriber account (e.g., IMSI) (“account,” as used herein), and thus are “related devices,” as used herein. For example, all related devices (e.g., device 102A, device 102B, device 102C, and/or device 102D) may have their own unique IMSI programmed into their respective SIM cards, and which are associated with a specific telephone number (MSISDN), which may also be unique to each related device (e.g., device 102A, device 102B, device 102C, and/or device 102D). But the IMSI and MSISDN pair may associated in the network with “alias numbers” to allow for shared lines and/or shared accounts, thereby making them related devices.

In at least one example, line and/or account associations for related devices (e.g., device 102A, device 102B, device 102C, and/or device 102D) may be stored in a database 212. Non-limiting examples of the IMSI and MSISDN associations for related devices (e.g., device 102A, device 102B, device 102C, and/or device 102D) are depicted in database 212. For instance, device 102A is associated with IMSI A and MSISDN A. Device 102B is associated with IMSI B and MSISDN B, but also with alias MSISDN A and alias IMSI A. Thus, device 102B is associated both with the same account and with the same line as device 102A. Device 102C is associated with IMSI C and MSISDN C, but also with alias IMSI A. Thus, device 102C shares an account (IMSI A) but not a telephone line with device 102A.

Some related devices (e.g., device 102D), which may not capable of connecting through a base station 208 of the cellular network 202, may also register with the cellular network 202 through the Internet 204 using a unique identifier, such as an IMPI or IMPU, a globally routable user agent URI (GRUU), or other. In at least one example, these identifiers may take the form of a telephone number (e.g., they may resemble a MSISDN). The cellular network 202 forwards calls and messages to the device 102D, and the device 102D may be enabled to send or receive shared video conversations in a same or similar way as with related devices (e.g., device 102A, device 102B, and/or device 102C). As illustrated in database 212 in FIG. 2, device 102D is associated with IMPU D and also with alias IMPU A. Device 102D therefore shares a telephone line with device 102A and device 102B and an account with device 102A, device 102B, and device 102C.

As described above, a related device (e.g., device 102A) may utilize presence information to determine which contacts correspond to related devices. For example, the presence information may include information about telephone numbers with which the mobile devices are registered. The related device (e.g., device 102A) may utilize the presence information—including for example an IP address or other information—to establish a connection with the related devices (e.g., device 102B, device 102C, and/or device 102D). The related device (e.g., device 102A) may utilize the connection to share a video conversation between it and an external device (e.g., device 106) with one or more of the other related devices (e.g., device 102B, device 102C, and/or device 102D) via the connection. A user of the related device (e.g., device 102A) may enable the video conversation to be shared with other related devices (e.g., device 102B, device 102C, and/or device 102D) via a user interface element. In some examples, the user of the related device (e.g., device 102A) may enable the video conversation to be shared with the other related devices (e.g., device 102B, device 102C, and/or device 102D) responsive to a request to join the video conversation. Alternatively, the related device (e.g., device 102A) may be configured to automatically transmit (e.g., without user intervention) an indication that shared video conversation is available. In some examples, the other related devices (e.g., device 102B, device 102C, and/or device 102D) may be configured to prompt a user of those devices (e.g., device 102B, device 102C, and/or device 102D) to accept establishment of the connection and/or to receive the shared video conversation.

In at least one example, the related device (e.g., device 102A) may establish a connection with one or more other related devices (e.g., device 102B, device 102C, and/or device 102D) to share a connection. In some examples, the connection may be established as a peer-to-peer connection directly between the related devices (e.g., device 102A and device 102B, device 102C, and/or device 102D). In additional and/or alternative examples, the connection may be established via a presence server 214, such as using the SIP protocol, which enables the establishment of a connection between related devices (e.g., device 102A and device 102B, device 102C, and/or device 102D).

The presence server 214 may retrieve data that corresponds to the IMSI, IMPU/IMPI of the related devices (e.g., device 102A, device 102B, device 102C, and/or device 102D) from the database 212. The data may include information specifying the associated device number (e.g., a MSISDN, IMPI, IMPU, or the like) for which the related devices (e.g., device 102A, device 102B, device 102C, and/or device 102D) are able to utilize for initiating, sending, and/or receiving communications. Thus, the presence information provided to a related device (e.g., device 102A) regarding one or more of the other related devices (e.g., device 102B, device 102C, and/or device 102D), which may indicate the shared line or account (e.g., may indicate whether and how the devices are related devices), may enable the related device (e.g., device 102A) to recognize that the other related devices (e.g., device 102B, device 102C, and/or device 102D) are related devices that share the same account and/or line as the device 102A, as well as to distinguish devices that are not related devices (such as device 106). In some examples, the related device (e.g., device 102A) may request from the presence server 214 a list of related devices (e.g., device 102B, device 102C, and/or device 102D).

As described above, a related device (e.g., device 102A) may be configured to obtain presence information for one or more contacts, including the related devices (e.g., device 102B, device 102C, and/or device 102D) from a presence server 214. The presence server 214 may be a SIP server, and the related device (e.g., device 102A) may be configured to utilize OMA Presence SIMPLE to obtain presence information regarding one or more contacts, including the related devices (e.g., device 102B, device 102C, and/or device 102D). In some examples, the related devices (e.g., device 102A, device 102B, device 102C, and/or device 102D) may be configured to provide their presence information to the presence server 214. Additionally and/or alternatively, the related devices (e.g., device 102A, device 102B, device 102C, and/or device 102D) may be configured to provide capabilities information to the presence server 214. The capabilities information may indicate an ability to receive instant messages, receive shared content, receive shared video conversations, and so forth. In other examples, the related devices (e.g., device 102A, device 102B, device 102C, and/or device 102D) may obtain each other's presence information and/or capabilities information in other ways, such as through static configuration, peer-to-peer connections, and so forth.

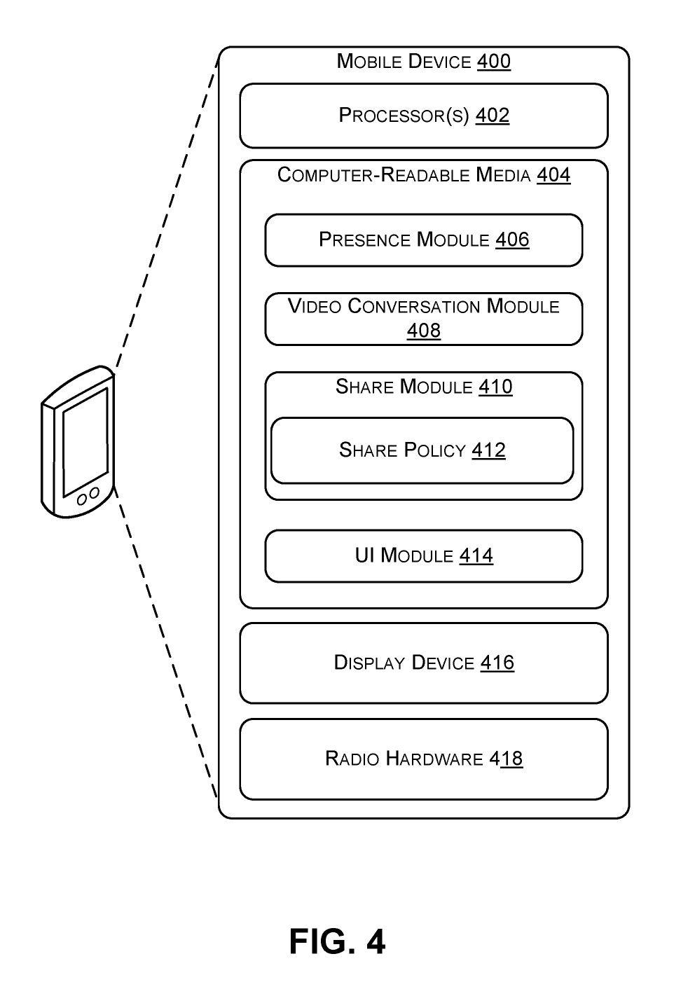

In some examples, the logic to enable cross-platform video conversation between related devices (e.g., device 102A, device 102B, device 102C, and/or device 102D) may be on the related devices (e.g., device 102A, device 102B, device 102C, and/or device 102D). In those examples, the related devices (e.g., device 102A, device 102B, device 102C, and/or device 102D) may enforce a share policy to enable certain video conversations to be shared amongst the related devices (e.g., device 102A, device 102B, device 102C, and/or device 102D), while preventing access to or sharing of the video conversations with other devices that are not related devices. Additional details associated with such examples are provided below with reference to FIG. 4.

In at least one example, the share policy may be based at least in part on presence information, capabilities information, and/or preference information. In some examples, the related devices (e.g., device 102A, device 102B, device 102C, and/or device 102D) may be configured to receive input regarding preferences for sharing video conversations. The input may correspond to preference information, which may indicate user specified preferences including, but not limited to, which related device(s) (e.g., device 102A, device 102B, device 102C, and/or device 102D) are preferred for the sharing of video conversations, which related device(s) (e.g., device 102A, device 102B, device 102C, and/or device 102D) are not preferred for the sharing of video conversations, which related device(s) (e.g., device 102A, device 102B, device 102C, and/or device 102D) a user prefers to automatically share video conversation with, which related device(s) (e.g., device 102A, device 102B, device 102C, and/or device 102D) a user prefers to select to share video conversation (instead of automatically sharing), etc.

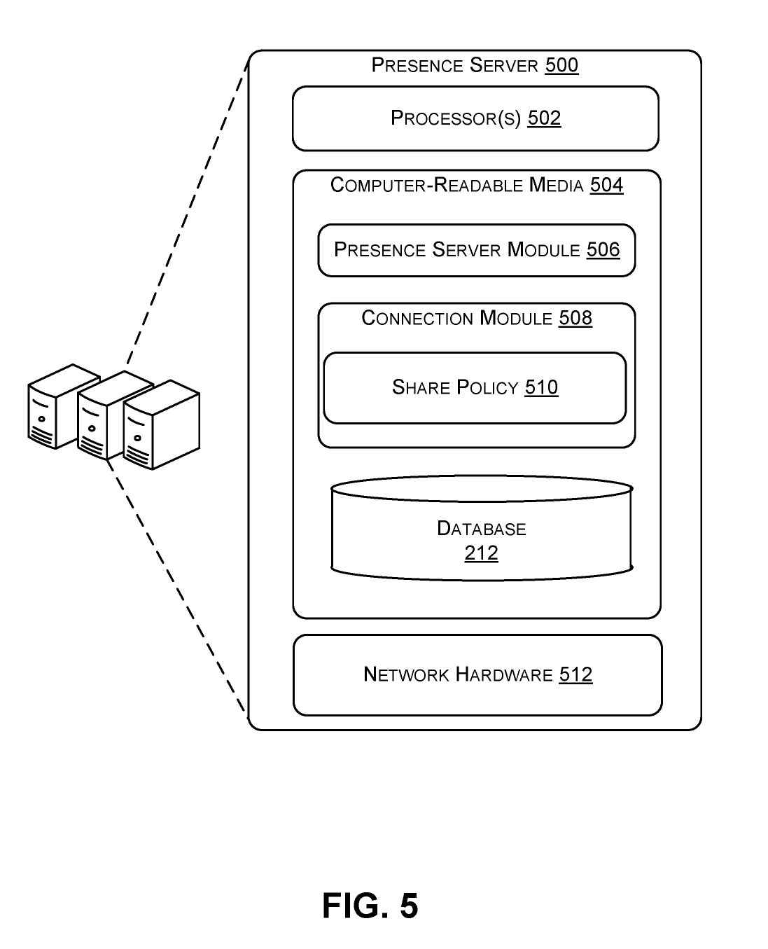

In additional and/or alternative examples, the video conversation sharing is established via the presence server 214. In such examples, the presence server 214 may enforce the share policy. In some examples, the share policy may limit video conversation sharing to related devices that share the same account, to related devices that share the same line, and so forth. The share policy may be based at least in part on presence information, capabilities information, and/or preference information, as described above. Additional details associated with such examples are provided below with reference to FIG. 5.

Examples are not limited to these examples, and the share policy may be enforced by other network elements, such as by a separate SIP server, by the recipient related device that receives the content, by the base stations 208, and so forth.

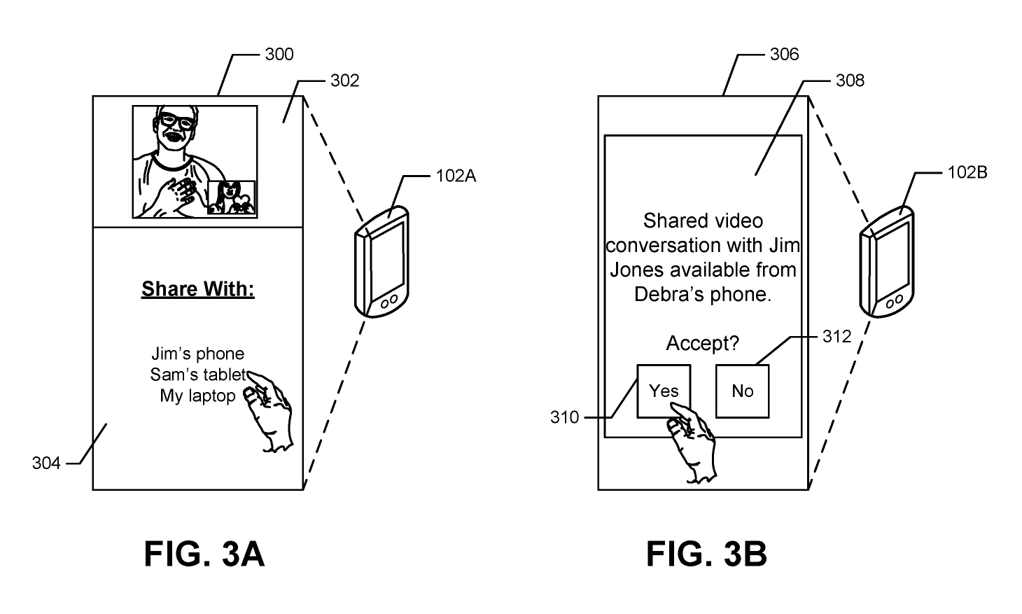

FIG. 3A illustrates a user interface 300 that enables a user associated with a related device (e.g., device 102A) to select one or more related devices (e.g., related device 102B, related device 102C, and/or related device 102D) to join a video conversation between the related device (e.g., device 102A) and an external device 106. The user interface 300 includes a first region 302 in which the video conversation with the external device 106 is displayed. That is, the user interface 300 may include a first region 302 in which live, simultaneous two-way video transmissions with the external device 106 are presented.

The user interface 300 also includes a second region 304 that lists the one or more related devices (e.g., device 102B, device 102C, and/or device 102D) with which the video conversation with the external device 106 may be selected for sharing. As illustrated in FIG. 3A, “Jim's phone” may correspond to device 102B, “Sam's tablet” may correspond to device 102C, and “my laptop” may correspond to device 102D. As described above, the list of related devices may include those related devices that are currently online (e.g., have registered their online presence with the presence server 214). In some examples, offline related devices may be omitted from the list presented in the second region 304. In other examples, offline related devices may be shown but indicated as offline in the list, such as by a grayed-out presentation, an “offline” indicator, or in some other way. Selection to share with an offline device may result in those devices being provided with a notification of the availability of shared content when they register their online presence. One or more indicators may be used to visually indicate which of the related devices (e.g., device 102B, device 102C, and/or device 102D) share the same account and/or the same line.

As described above, a share policy may permit sharing of a video conversation with one or more of the related devices that share an account. In some examples, a share policy may enable or permit sharing of a video conversation with one or more related devices that share a same line, while preventing sharing of a video conversation with related devices that do not share a same line (e.g., those that share a subscriber account, but not the same line). Thus, in some examples, the list may include the related devices for which sharing is permitted, and omit those devices for which sharing is not permitted, such as based on those devices not sharing the same account, not sharing the same line, etc. In other examples, those related devices for which sharing of video conversation(s) is not permitted may be listed but indicated as not allowed to share video conversation(s), such as by a grayed-out presentation or by some other visual indicator.

Although the example illustrated in FIG. 3A shows the first region 302 of the user interface 300 as being displayed simultaneously with the second region 304 of the user interface 300, examples of the present disclosure are not limited to simultaneous display. In some examples, the video transmission associated with the video conversation can be viewed before or after sharing. In some examples, the video transmission associated with the video conversation may not be displayed on the device that shares it at all. Other examples are possible without departing from the scope of this disclosure.

FIG. 3B illustrates a user interface 306 for a related device (e.g., device 102B) that enables a user of the related device (e.g., device 102B) to select to join a video conversation with an external device 106. The user interface 306 may include a region 308, which may include a pop-up or other notification that indicates that a video conversation is available for the related device (e.g., device 102B). The user interface 306 may include user selectable elements 310 and 312 that enable the user to accept or decline the video conversation, respectively.

User interfaces 300 and 306 illustrated in FIGS. 3A and 3B, respectively, are examples only. Other examples are possible without departing from the scope of this disclosure.

FIG. 4 illustrates an example mobile device 400 configured to enable related devices to join a video conversation with an external device 106. Mobile device 400 may correspond to any one of related devices (e.g., device 102A, device 102B, device 102C, and/or device 102D); however, for the purpose of this discussion, mobile device 400 corresponds to device 102A. As illustrated in FIG. 4, the mobile device 400 includes processor(s) 402 and computer-readable media 404.

Processor(s) 402 can represent, for example, a CPU-type processing unit, a GPU-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 402 can execute one or more modules and/or processes to cause the mobile device 400 to perform a variety of functions, as set forth above and explained in further detail in the following disclosure. Additionally, each of the processor(s) 402 can possess its own local memory, which also can store program modules, program data, and/or one or more operating systems.

Depending on the exact configuration and type of the mobile device 400, the computer-readable media 404, can include computer storage media and/or communication media.

Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In at least one example, the computer storage media can include non-transitory computer-readable media. Non-transitory computer-readable media can include volatile and nonvolatile, removable and non-removable tangible, physical media implemented in technology for storage of information, such as computer readable instructions, data structures, program modules, or other data. Computer-readable media 404 is an example of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the mobile device 400. Any such non-transitory computer-readable media can be part of the mobile device 400.

In contrast, communication media includes computer readable instructions, data structures, program modules, or other data in a modulated data signal, such as a carrier wave, or other transmission mechanism. As defined herein, computer storage media does not include communication media.

The computer-readable media 404 can include one or more modules and data structures including, for example, a presence module 406, a video conversation module 408, a share module 410, including a share policy 412, and a UI module 414. The one or more modules and data structures can be in the form of stand-alone applications, productivity applications, an operating system component, or any other application or software module having features that facilitate interactions between related devices (e.g., device 102A, device 102B, device 102C, and/or device 102D), external device(s) (e.g., device 106), the presence server 214, and/or one or more networks as described herein.

The presence module 406 may be configured to retrieve presence information for one or more related devices (e.g., device 102A, device 102B, device 102C, and/or device 102D). The related devices (e.g., device 102A, device 102B, device 102C, and device 102D) share a same account and/or a same line for sending and receiving at least cellular communications, as described elsewhere within this detailed description. In at least one example, the related devices (e.g., device 102A, device 102B, device 102C, and/or device 102D) may include cellular telephone devices that are configured to utilize a shared telephone number to send and receive cellular communications via the cellular network. In additional and/or alternative examples, the related devices (e.g., device 102A, device 102B, device 102C, and device 102D) may include related devices that connect via a Wi-Fi or other access network to the Internet or other packet-based network. The presence module 406 may be configured to retrieve the presence information from the presence server 214, such as via OMA Presence SIMPLE protocol, or in some other fashion.

The video conversation module 408 may be configured to facilitate video conversations between related devices (e.g., device 102A, device 102B, device 102C, and device 102D) and/or an external device (e.g., device 106). The video conversation module 408 may be configured to simultaneously exchange live video and audio transmissions between devices via a computing platform such as IR.94 and/or various web-based applications including, but not limited to, FACETIME®, SKYPE®, GOOGLE+ HANGOUTS®, etc., as described above. For instance, the video conversation module 408 may be configured to send live video and audio transmissions to at least an external device (e.g., device 106). Additionally, the video conversation module 408 may be configured to receive live video and audio transmissions from the external device (e.g., device 106). The video conversation module 408 may be configured to cause the live video transmissions received from the external device (e.g., device 106) to be displayed on a display device 416. Display 112 and display 130 with reference to FIG. 1 may each correspond to a display device 416.

In at least one example, the share module 410 may be configured to enable a user of the mobile device 400 to share live video and audio transmissions from an external device (e.g., device 106) with at least one related device (e.g., device 102B, device 102C, and/or device 102D). In additional and/or alternative examples, the share module 410 may be configured to enable a user of the mobile device 400 to access a live video and audio transmission that is received by another related device (e.g., device 102B, device 102C, and/or device 102D) from an external device (e.g., device 106), and is being shared with the mobile device 400 by the other related device (e.g., device 102B, device 102C, and/or device 102D). The share module 410 may be configured to establish a connection, such as via a presence server 214 or via a peer-to-peer connection, with a share module of another related device. In some examples, the presence information may be utilized by the share module 410 to establish a connection between the mobile device 400 and the related device(s) (e.g., device 102B, device 102C, and/or device 102D), in order to share the live, simultaneous two-way video and audio transmissions between the mobile device 400 and one or more related devices (e.g., device 102B, device 102C, and/or device 102D).

In at least one example, the share module 410 may be configured to enforce a share policy 412. In some examples, the share policy may be based at least in part on presence information, capabilities information, and/or preference information, as described above. In some examples, the share policy 412 may indicate that certain video conversations may be shared with related devices, and that such video conversations may not to be shared with other devices that do not share a line or account with the device that received the live video and audio transmission from the external device (e.g., device 106). In other examples, the share policy 412 may indicate that certain video conversations may be shared with certain related devices, and that such video conversations may not be shared with other related devices. In some examples, the presence information includes information regarding telephone numbers that are associated with the related devices (e.g., device 102A, device 102B, device 102C, and/or device 102D), and the share module 410 may be configured to restrict sharing of the video conversations to the one or more related devices (e.g., device 102B, device 102C, and/or device 102D) based at least on the information regarding telephone numbers indicating that the one or more related devices share the telephone number with the mobile device 400.

The user interface module 414 may be configured to cause, via a user interface associated with the mobile device 400, a presentation of a list of one or more related devices (e.g., device 102B, device 102C, and/or device 102D) that are permitted to receive a shared video conversation. The user interface may be interactive to receive user selection of at least one related device (e.g., device 102B, device 102C, and/or device 102D) for sharing of the video conversation. Additional details associated with such a user interface are described above with reference to FIG. 3A. Additionally and/or alternatively, the user interface module 414 may cause a presentation of a request to receive a shared video conversation. The user interface may be interactive to receive user selection indicating whether the user accepts the shared video conversation. Additional details associated with such a user interface are described above with reference to FIG. 3B.

The user interface module 414 may interact with the share module 410, such as by calling an Application Programming Interface (API) or other, to initiate the sharing of the live, simultaneous two-way video and audio transmissions between the devices participating in a video conversation. The user interface module 414 may interact with the presence module 406, such as by calling another API or other, to retrieve the list of related devices, including their current online presence status (e.g., online or offline, busy, accepting shared content, etc.).

Radio hardware 418 provides wireless UE capabilities, such as connecting to a cellular network base station, a Wi-Fi network, or other wireless network. The radio hardware 418 may include or be incorporated into processors, application-specific integrated circuits (ASICs), programmable circuits such as field programmable gate arrays (FPGAs), or in other ways. The software modules stored on the computer-readable media 404 are configured to access hardware via interrupts, calling APIs, and the like. The software modules may also be configured to pass information to one another, such as through APIs, by storing commands, parameters, etc. in a predetermined memory location, etc. Other examples are possible without departing from the scope of this disclosure.

FIG. 5 illustrates an example presence server 500 configured to provide presence information for related devices. In at least one example, presence server 500 may correspond to presence server 214 with reference to FIG. 2.

As illustrated in FIG. 5, the presence server 500 includes processor(s) 502 and computer-readable media 504. Processor(s) 502 can represent, for example, a CPU-type processing unit, a GPU-type processing unit, a Field-Programmable Gate Array (FPGA), another class of Digital Signal Processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-Chip systems (SOCs), Complex Programmable Logic Devices (CPLDs), etc. In at least one example, an accelerator can represent a hybrid device, such as one from ZYLEX or ALTERA that includes a CPU course embedded in an FPGA fabric. In various embodiments, the processor(s) 502 can execute one or more modules and/or processes to cause the presence server 500 to perform a variety of functions, as set forth above and explained in further detail in the following disclosure. Additionally, each of the processor(s) 502 can possess its own local memory, which also can store program modules, program data, and/or one or more operating systems.

Depending on the exact configuration and type of the presence server 500, the computer-readable media 504, can include computer storage media and/or communication media.

Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In at least one example, the computer storage media can include non-transitory computer-readable media. Non-transitory computer-readable media can include volatile and nonvolatile, removable and non-removable tangible, physical media implemented in technology for storage of information, such as computer readable instructions, data structures, program modules, or other data. Computer-readable media 504 is an example of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the presence server. Any such non-transitory computer-readable media can be part of the presence server.

In contrast, communication media includes computer readable instructions, data structures, program modules, or other data in a modulated data signal, such as a carrier wave, or other transmission mechanism. As defined herein, computer storage media does not include communication media.

The computer-readable media 504 can include one or more modules and data structures including, for example, a presence server module 506, a connection module 508, including a share policy 510, and database 212. The one or more modules and data structures can be in the form of stand-alone applications, productivity applications, an operating system component, or any other application or software module having features that facilitate interactions between the presence server 500, one or more related devices (e.g., device 102A, device 102B, device 102C, and/or device 102D), and/or one or more networks, as described herein.

The presence server module 506 may provide presence server services to UEs, such as the related devices (e.g., device 102A, device 102B, device 102C, and/or device 102D). The presence server module 506 may be configured to register online presence information of various devices, and/or to provide presence information and/or capabilities information, as described above, regarding the various devices. The presence server module 506 may look up information regarding groups of related devices in the database 212, and provide presence information and/or capabilities information regarding those related devices (e.g., device 102A, device 102B, device 102C, and/or device 102D) to other ones of the related devices (e.g., device 102A, device 102B, device 102C, and/or device 102D). The presence server module 506 may be configured to receive requests from devices for presence information, capabilities information, and/or preference information for contacts generally, including for related devices (e.g., device 102A, device 102B, device 102C, and/or device 102D). The presence server module 506 may be configured to receive requests from devices for a list of related devices. The presence server module 506 may be configured to provide information indicating which, if any, devices are related devices associated with the requesting device. The presence serve module 506 may be configured to provide presence information and/or capabilities information using OMA Presence SIMPLE protocol, or in some other fashion.

The connection module 508 may be configured, in some embodiments, to facilitate establishment of connections between devices, including establishment of connections between related devices (e.g., device 102A, device 102B, device 102C, and/or device 102D). In some examples, the connection module 508 may be configured to utilize a share policy 510. The share policy may be based at least in part on presence information, capabilities information, and/or preference information, as described above. The share policy 510 may indicate that certain video conversations may be shared with related devices (e.g., device 102A, device 102B, device 102C, and/or device 102D), and that such video conversations may not to be shared with other devices that do not share a line or account with the device that received the live video and audio transmission. In other examples, the share policy 510 may indicate that certain video conversations that may be shared with certain related devices (e.g., device 102A, device 102B, device 102C, and/or device 102D), and that such video conversations may not to be shared with other related devices (e.g., device 102A, device 102B, device 102C, and/or device 102D). The connection module 508 may therefore allow certain video conversations to be shared with certain related devices (e.g., device 102A, device 102B, device 102C, and/or device 102D), but deny requests to establish a connection and/or share video conversations with other devices.

Network hardware 512 provides wired or wireless networking capabilities to the presence server 500. The network hardware 512 may include or be incorporated into processors, application-specific integrated circuits (ASICs), programmable circuits such as field programmable gate arrays (FPGAs), or in other ways. The software modules stored on the computer-readable media 504 are configured to access hardware via interrupts, calling APIs, and the like. The software modules may also be configured to pass information to one another, such as through APIs, storing commands, parameters, etc. in a predetermined memory location, etc. Other examples are possible without departing from the scope of this disclosure.

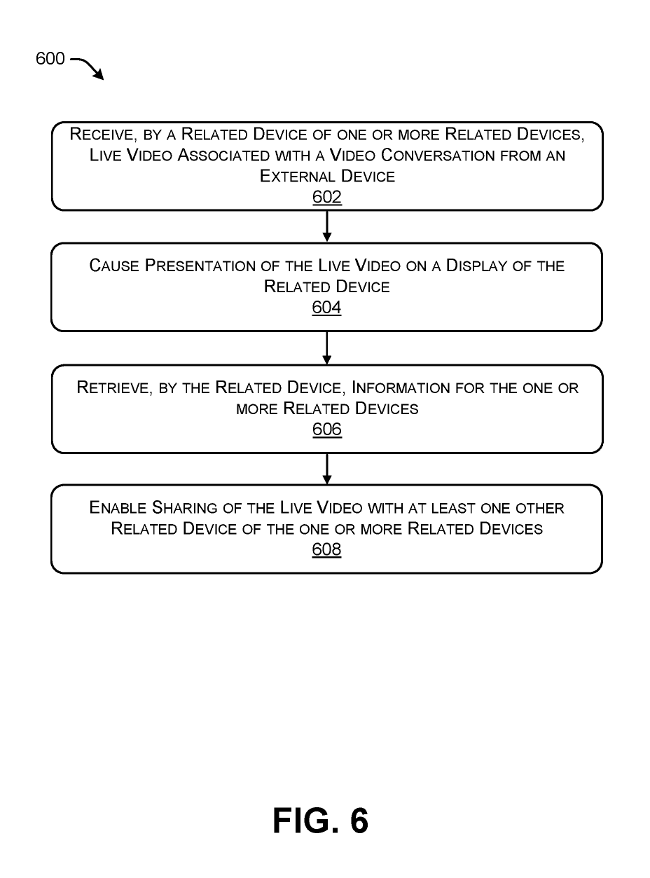

FIGS. 6-10 describe example processes for sharing video conversations between related devices. The example processes are described in the context of the environments of FIGS. 1-5, but are not limited to those environments.

FIG. 6 illustrates an example process 600 for enabling sharing video conversations between related devices.

Block 602 illustrates receiving, by a related device of one or more related devices, live video associated with a video conversation from an external device. In at least one example, a related device (e.g., mobile device 400 and/or device 102A) may receive live video associated with a video conversation from an external device (e.g., device 106) via a wireless connection. As described above, the video conversation module 408 associated with a related device (e.g., mobile device 400 and/or device 102A) may be configured to simultaneously exchange live video and audio transmissions between devices via a computing platform such as IR.94 and/or various web-based applications including, but not limited to, FACETIME®, SKYPE®, GOOGLE+ HANGOUTS®, etc. For instance, the video conversation module 408 may be configured to send live video and audio transmissions to at least an external device (e.g., device 106). Additionally, the video conversation module 408 may be configured to receive live video and audio transmissions from the external device (e.g., device 106).

Block 604 illustrates causing presentation of the live video on a display of a related device of one or more related devices. In at least one example, the related device (mobile device 400 and/or device 102A) may present the live video received from the external device (e.g., device 106) on a display of the related device (e.g., mobile device 400 and/or device 102A). Additional details associated with causing presentation of the live video on a display of a related device are described above with reference to FIG. 1.

Block 606 illustrates retrieving, by the related device, information for the one or more related devices. In at least one example, the presence module 406 may be configured to retrieve presence information and/or capabilities information for one or more related devices (e.g., mobile device 400 and/or device 102A, device 102B, device 102C, and device 102D). The presence module 406 may be configured to retrieve the presence information and/or capabilities information from the presence server 214, such as via OMA Presence SIMPLE protocol, or in some other fashion, as described above.

Block 608 illustrates enabling sharing of the live video with at least one other related device of the one or more related devices. In at least one example, the share module 410 may be configured to enable a user of a related device (e.g., mobile device 400 and/or device 102A) to share live video and audio transmissions from an external device (e.g., device 106) with at least one other related device (e.g., device 102B, device 102C, and/or device 102D). In additional and/or alternative examples, the share module 410 may be configured to enable a user of the related device (e.g., mobile device 400 and/or device 102A) to access a live video and audio transmission that is received by another related device (e.g., device 102B, device 102C, and/or device 102D) from an external device (e.g., device 106), and is being shared with the related device (e.g., mobile device 400 and/or device 102A) by the other related device (e.g., device 102B, device 102C, and/or device 102D). The share module 410 may be configured to establish a connection, such as via a presence server 214 or via a peer-to-peer connection, with a share module of another related device. In some examples, the presence information is utilized by the share module 410 to establish a connection between the related device (e.g., mobile device 400 and/or device 102A) and the related device(s) (e.g., device 102B, device 102C, and/or device 102D), in order to share the live, simultaneous two-way video and audio transmissions between the related device (e.g., mobile device 400 and/or device 102A) and the other related device(s) (e.g., device 102B, device 102C, and/or device 102D).

In at least one example, the share module 410 may be configured to enforce a share policy 412. In some examples, the share policy 412 may indicate that certain video conversations may be shared with related devices (e.g., device 102B, device 102C, and/or device 102D), and that such video conversations may not to be shared with other devices that do not share a line or account with the device that received the live video and audio transmission from the external device (e.g., device 106). In other examples, the share policy 412 may indicate that certain video conversations may be shared with certain related devices (e.g., device 102B, device 102C, and/or device 102D), and that such video conversations may not be shared with other related devices (e.g., device 102B, device 102C, and/or device 102D), as described above with reference to FIG. 4.

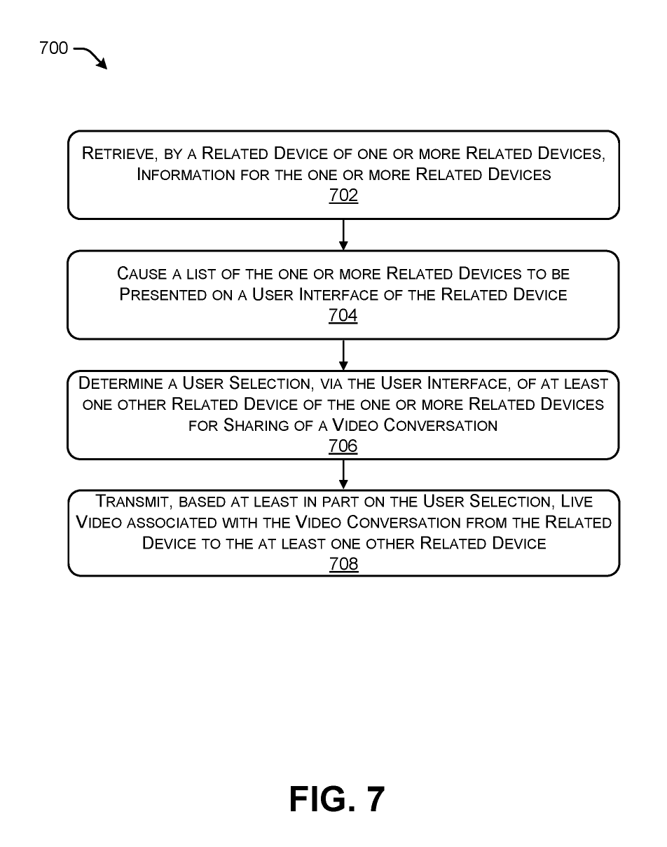

FIG. 7 illustrates an example process 700 for sharing video conversations between related devices.

Block 702 illustrates retrieving, by a related device of one or more related devices, information for the one or more related devices. As described above, in at least one example, a presence module 406 associated with a related device (e.g., mobile device 400/device 102) may be configured to retrieve presence information and/or capabilities information for one or more related devices (e.g., mobile device 400 and/or device 102A, device 102B, device 102C, and device 102D). The presence module 406 may be configured to retrieve the presence information and/or capabilities information from the presence server 214, such as via OMA Presence SIMPLE protocol, or in some other fashion, as described above.

Block 704 illustrates causing a list of the one or more related devices to be presented on a user interface of the related device. In at least one example, the user interface module 414 may be configured to cause, via a user interface associated with the related device (e.g., mobile device 400 and/or device 102A), a presentation of a list of one or more related devices (e.g., device 102B, device 102C, and/or device 102D) that are permitted to receive a shared video conversation. In at least one example, the user interface module 414 may interact with the presence module 406, such as by calling another API or other, to retrieve the list of related devices, including their current online presence status (e.g., online or offline, busy, accepting shared content, etc.).

Block 706 illustrates determining a user selection, via the user interface, of at least one other related device of the one or more related devices for sharing of a video conversation. The user interface may be interactive to receive user selection of at least one other related device (e.g., device 102B, device 102C, and/or device 102D) for sharing of the video conversation. Additional details associated with such a user interface are described above with reference to FIG. 3A.

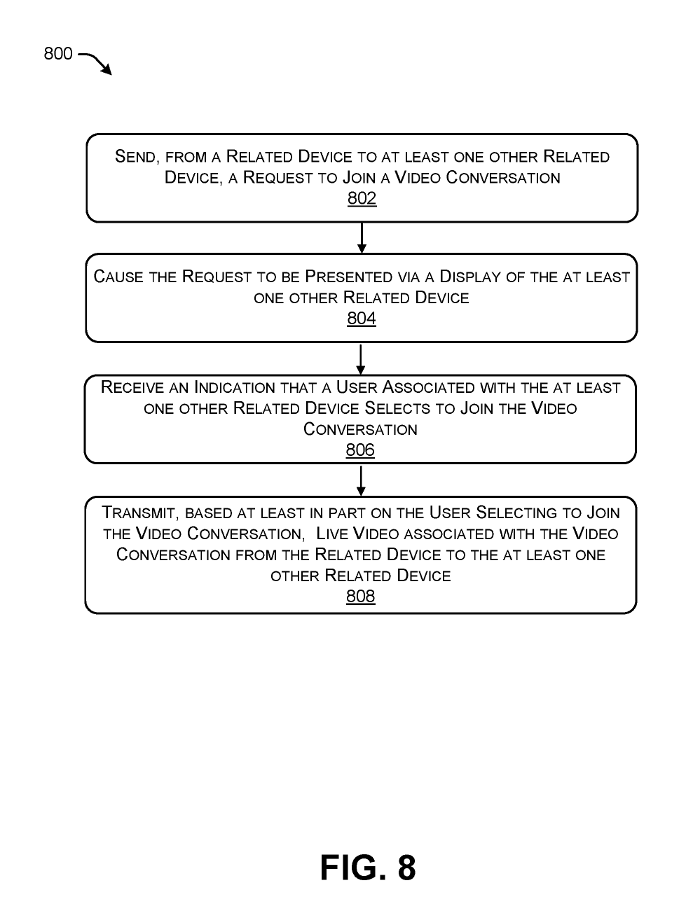

Block 708 illustrates transmitting, based at least in part on the user selection, live video associated with the video conversation from the related device to the at least one other related device. The user interface module 414 may interact with the share module 410, such as by calling an Application Programming Interface (API) or other, to initiate the sharing of the live, simultaneous two-way video and audio transmissions with the at least one other related device (e.g., device 102B, device 102C, and/or device 102D), as described above. In some examples, the user interface module 414 may refrain from initiating the sharing of the live, simultaneous two-way video and audio transmissions with the at least one other related device (e.g., device 102B, device 102C, and/or device 102D) until it receives an indication that a user associated with the at least one other related device (e.g., device 102B, device 102C, and/or device 102D) accepts a request to join the video conversation, as described below with reference to FIG. 8.

FIG. 8 illustrates another example process 800 for sharing video conversations between related devices.

Block 802 illustrates sending, from a related device to at least one other related device, a request to join a video conversation. In at least one example, the user interface module 414 may be configured to cause, via a user interface associated with a related device (e.g., mobile device 400 and/or device 102A), a presentation of a list of one or more related devices (e.g., device 102B, device 102C, and/or device 102D) that are permitted to receive a shared video conversation on a user interface associated with the related device (e.g., mobile device 400 and/or device 102A). In at least one example, the user interface may be interactive to receive user selection of at least one other related device (e.g., device 102B, device 102C, and/or device 102D) for sharing of the video conversation. Additional details associated with such a user interface are described above with reference to FIG. 3A. In at least one example, based at least in part on a user selection of at least one other related device (e.g., device 102B, device 102C, and/or device 102D) for sharing of the video conversation, the related device (e.g., mobile device 400 and/or device 102A) may send a request to join a video conversation to the at least one other related device (e.g., device 102B, device 102C, and/or device 102D). In some examples, the related device (e.g., mobile device 400 and/or device 102A) may send the request directly to at least one other related device (e.g., device 102B, device 102C, and/or device 102D), to the presence server (e.g., presence server 500 and/or presence server 214), or in some other way.

Block 804 illustrates causing a request to be presented via a display of the at least one other related device. Based at least in part on the user selection of at least one other related device (e.g., device 102B, device 102C, and/or device 102D), the user interface module 414 may cause, via a user interface associated with the at least one related device (e.g., device 102B, device 102C, and/or device 102D), presentation of a request to receive a shared video conversation via a display associated with the at least one other related device (e.g., device 102B, device 102C, and/or device 102D). Additional details associated with such a user interface are described above with reference to FIG. 3B.

Block 806 illustrates receiving an indication that a user associated with the at least one other related device selects to join the video conversation. As described above, the user interface may be interactive to receive a user selection indicating whether the user accepts the shared video conversation. In at least one example, the related device (e.g., mobile device 400 and/or device 102A) may receive an indication that a user associated with the at least one other related device (e.g., device 102B, device 102C, and/or device 102D) selects to join the video conversation.

Block 808 illustrates transmitting, based at least in part on the user selecting to join the video conversation, live video associated with a video conversation from the related device to the at least one other related device. Based at least in part on receiving an indication that the user selected to accept the shared video conversation, and therefore join the video conversation, the user interface module 414 may interact with the share module 410, such as by calling an Application Programming Interface (API) or other, to initiate the sharing of the live, simultaneous two-way video and audio transmissions with the at least one other related device (e.g., device 102B, device 102C, and/or device 102D), as described above.

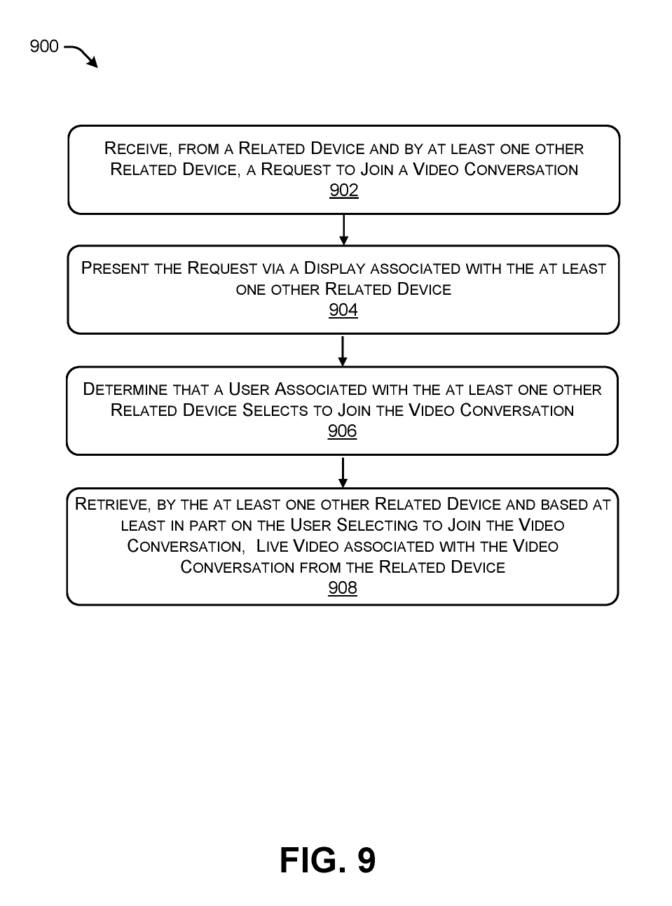

FIG. 9 illustrates yet another example process 900 for sharing video conversations between related devices.

Block 902 illustrates receiving, from a related device and by at least one other related device, a request to join a video conversation. As described above, in at least one example, the user interface module 414 associated with a related device (e.g., mobile device 400 and/or device 102A) may be configured to cause, via a user interface associated with the related device (e.g., mobile device 400 and/or device 102A), a presentation of a list of one or more related devices (e.g., device 102B, device 102C, and/or device 102D) that are permitted to receive a shared video conversation on a user interface associated with the related device (e.g., mobile device 400 and/or device 102A). In at least one example, the user interface may be interactive to receive user selection of at least one other related device (e.g., device 102B, device 102C, and/or device 102D) for sharing of the video conversation. Based at least in part on the user selection of the at least one other related device (e.g., device 102B, device 102C, and/or device 102D), the at least one other related device (e.g., device 102B, device 102C, and/or device 102D) can receive a request to join the video conversation from the related device (e.g., mobile device 400 and/or device 102A), from a presence server (e.g., presence server 500 and/or presence server 214), or in some other way.

Block 904 illustrates presenting the request via a display associated with the at least one other related device. A user interface module 414 associated with the at least one other related device (e.g., device 102B, device 102C, and/or device 102D) may cause, via a user interface associated with the at least one other related device (e.g., device 102B, device 102C, and/or device 102D), presentation of a request to receive a shared video conversation via a display associated with the at least one other related device (e.g., device 102B, device 102C, and/or device 102D). Additional details associated with such a user interface are described above with reference to FIG. 3B.

Block 906 illustrates determining that a user associated with the at least one other related device selects to join the video conversation. The user interface module 414 associated with the at least one other related device (e.g., device 102B, device 102C, and/or device 102D) may determine that a user associated with the at least one other related device (e.g., device 102B, device 102C, and/or device 102D) selects to accept the shared video conversation based at least in part on the user providing some indication such as by interacting with a selectable element, or some other interaction. In at least one example, the at least one other related device (e.g., device 102B, device 102C, and/or device 102D) may enforce a share policy, such that it allows the user to accept certain shared video conversations from related devices, and not from other devices.

Block 908 illustrates retrieving, by the at least one other related device and based at least in part on the user selecting to join the video conversation, live video associated with the video conversation from the related device. Based at least in part on the user associated with the at least one other related device (e.g., device 102B, device 102C, and/or device 102D) selecting to accept the shared video conversation, and therefore join the video conversation, the user interface module 414 associated with the at least one other related device (e.g., device 102B, device 102C, and/or device 102D) may retrieve the live video associated with the video conversation for presenting via a user interface associated with a display of the at least one other related device (e.g., device 102B, device 102C, and/or device 102D).

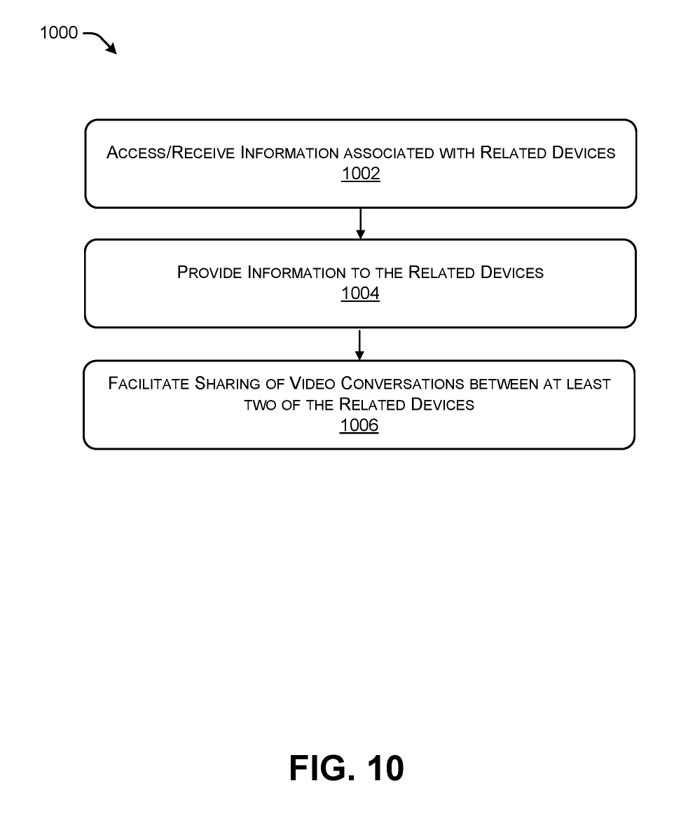

FIG. 10 illustrates an example process 1000 for enabling sharing of video conversations between related devices.

Block 1002 illustrates accessing and/or receiving information from related devices. In at least one example, a presence server module 506 associated with a presence server (e.g., presence server 500 and/or presence server 214) may access and/or receive presence information associated with one or more related devices (e.g., device 102A, device 102B, device 102C, and/or device 102D). As described above, in some examples, the presence server module 506 may register the presence and/or capabilities of one or more related devices (e.g., device 102A, device 102B, device 102C, and/or device 102D). Additionally and/or alternatively, the presence server module 506 may receive preferences associated with one or more related devices (e.g., device 102A, device 102B, device 102C, and/or device 102D). The presence server module 506 may register the online presence, capabilities, and/or preferences in some embodiments via OMA Presence SIMPLE protocol, or in some other way.

Block 1004 illustrates providing information to the related devices (e.g., device 102A, device 102B, device 102C, and/or device 102D). In at least one example, the presence server module 506 may provide presence information and/or capabilities information regarding one or more related devices (e.g., device 102A, device 102B, device 102C, and/or device 102D). The presence server module 506 may look up information regarding groups of related devices in the database 212, and provide presence information and/or capabilities information regarding those related devices (e.g., device 102A, device 102B, device 102C, and/or device 102D) to other ones of the related devices (e.g., device 102A, device 102B, device 102C, and/or device 102D). The presence server module 506 may be configured to receive requests from devices for presence information and/or capabilities information for contacts generally, including for related devices (e.g., device 102A, device 102B, device 102C, and/or device 102D). The presence server module 506 may be configured to receive requests from devices for a list of related devices. The presence server module 506 may be configured to provide information indicating which, if any, devices are related devices associated with the requesting device. The presence serve module 506 may be configured to provide presence information and/or capabilities information using OMA Presence SIMPLE protocol, or in some other fashion.

Block 1006 illustrates facilitating sharing of video conversations between at least two of the related devices. As described above, the connection module 508 may be configured, in some embodiments, to facilitate establishment of connections between devices, including establishment of connections between related devices (e.g., device 102A, device 102B, device 102C, and/or device 102D). In some examples, the connection module 508 may be configured to utilize a share policy 510. The share policy 510 may indicate that certain video conversations may be shared with related devices (e.g., device 102A, device 102B, device 102C, and/or device 102D), and that such video conversations may not to be shared with other devices that do not share a line or account with the device that received the live video and audio transmission. In other examples, the share policy 510 may indicate that certain video conversations that may be shared with certain related devices, and that such video conversations may not to be shared with other related devices. The connection module 508 may therefore allow certain video conversations to be shared with certain related devices (e.g., device 102A, device 102B, device 102C, and/or device 102D), but deny requests to establish a connection and/or share video conversations with other devices.

The processes described above in association with FIGS. 6-10 can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. In other embodiments, hardware components perform one or more of the operations. Such hardware components may include or be incorporated into processors, application-specific integrated circuits (ASICs), programmable circuits such as field programmable gate arrays (FPGAs), or in other ways. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, by a first device, live video associated with a video conversation from a second device via a wireless connection, the first device registered with a network to utilize a communication address for sending and receiving communications via the network;
causing, by the first device, presentation of the live video on a display of the first device;
retrieving, by the first device, information for one or more related devices, the one or more related devices being related to the first device based on at least one of utilizing the communication address for sending and receiving at least communications via the network or being associated with a same subscriber account as the first device; and
enabling the first device to share the live video with at least one related device of the one or more related devices to enable the at least one related device to join the video conversation.

2. The method of claim 1, further comprising:
causing, by the first device, a presentation of a list of the one or more related devices on a user interface of the first device; and
transmitting, based at least on user selection via the user interface of the first device, the live video to the at least one related device.

3. The method of claim 1, wherein the live video is received by the first device via a first computing platform associated with providing conversational video services.

4. The method of claim 3, wherein the at least one related device is associated with a second computing platform associated with providing conversational video services that is different than the first platform.

5. The method of claim 1, wherein the retrieving information for the one or more related devices includes retrieving presence information from a server via Session Initiation Protocol (SIP).

6. The method of claim 5, wherein the presence information includes information regarding at least one of communication addresses or subscriber account numbers that are associated with the one or more related devices, and the method further comprises determining the one or more related devices based on at least one of the information regarding at least one of the communication addresses or the subscriber account numbers.

7. The method of claim 5, wherein the presence information is utilized to establish a connection between the first device and the at least one related device and the method further comprises sharing the live video with the at least one related device via the connection.

8. A mobile device comprising:
a display;
one or more processors;
memory;
a plurality of programming instructions stored on the memory and executable by the one or more processors to implement:
a presence module configured to retrieve presence information for one or more related devices, the one or more related devices and the mobile device sharing at least one of a telephone number for sending and receiving at least communications via a network or a subscriber account number associated with the network;
a video conversation module configured to:
facilitate a video conversation with an external device via the network, the video conversation including an exchange of real-time video and audio transmissions between the mobile device and the external device; and
cause a video transmission associated with the video conversation to be presented on the display; and
a share module configured to enable a user of the mobile device to share the video conversation with at least one related device of the one or more related devices.

9. The mobile device of claim 8, further comprising a user interface module, the user interface module configured to cause presentation via a user interface of a list of the one or more related devices, the user interface being interactive to receive user selection of the at least one related device for sharing of the video conversation.

10. The mobile device of claim 8, wherein the video conversation is facilitated by a first video conversation computing platform that is unavailable to the at least one related device.

11. The mobile device of claim 10, wherein the at least one related device is associated with a second video conversation computing platform that is different than the first video conversation computing platform.

12. The mobile device of claim 8, wherein the share module is further configured to share the video conversation with the at least one related device without interrupting the video conversation with the external device.

13. The mobile device of claim 8, wherein the presence module is configured to retrieve the presence information for the one or more related devices by retrieving presence information from a server via Session Initiation Protocol (SIP).

14. The mobile device of claim 13, wherein the presence information includes information regarding telephone numbers that are associated with the one or more related devices, and the share module is further configured to restrict sharing of the video conversation to the one more related devices based at least on the information regarding telephone numbers indicating that the one or more related devices share the telephone number with the mobile device.

15. The mobile device of claim 13, wherein:
the presence information is utilized to establish a connection between the mobile device and the at least one related device; and
the video conversation is shared with the at least one related device via the connection.

16. A mobile device, comprising:
a display;
one or more processors;
memory; and
a plurality of programming instructions stored on the memory and executable by the one or more processors to implement:
a presence module configured to retrieve presence information for one or more related devices, the one or more related devices and the mobile device sharing at least one of a telephone number for sending and receiving at least communications via a network or a subscriber account number associated with the network;
a share module configured to enable a user of the mobile device to select a video transmission associated with a video conversation between at least one related device of the one or more related devices and an external device that is being shared by the at least one related device; and
a content module configured to retrieve the video transmission from the at least one related device and to cause the video transmission to be presented on the display.

17. The mobile device of claim 16, wherein retrieving the presence information for one or more related devices is based at least in part on retrieving presence information from a server via Session Initiation Protocol (SIP).

18. The mobile device of claim 16, wherein the presence information includes information regarding telephone numbers and subscriber account numbers that are associated with the one or more related devices.

19. The mobile device of claim 16, wherein:
the presence information is utilized to establish a connection between the mobile device and the at least one related device; and
the video transmission is shared with the mobile device via the connection.

20. The mobile device of claim 16, further comprising a user interface module configured to cause a presentation via a user interface of a request from the at least one related device to join the video conversation, the user interface being interactive to receive an indication that the user accepts the request.
